(19) United States
(12) Patent Application Publication
(10) Pub. No.: US 2024/0075889 A1
(43) Pub. Date: Mar. 7, 2024

(54) FASTENING OF A HIGH-VOLTAGE DUAL RAIL

(71) Applicant: Lisa Draexlmaier GmbH, Vilsbiburg (DE)

(72) Inventors: Franziska NEUMAYER, Geisenhausen (DE); Stefan WIMMER, Hohenthann (DE); Robert SALLER, Egglkofen (DE); Florian KOMAR, Velden (DE); Simon EGGL, Hohenthann (DE)

(73) Assignee: Lisa Draexlmaier GmbH, Vilsbiburg (DE)

(21) Appl. No.: 18/461,000

(22) Filed: Sep. 5, 2023

(30) Foreign Application Priority Data
Sep. 2, 2022 (DE) 102022122262.4

(51) Int. Cl. B60R 16/02; H02G 1/00

(52) U.S. Cl. CPC B60R 16/0215; H02G 1/00

(57) ABSTRACT

A device for mounting a dual rail on a vehicle includes an elastic cushion and a mounting bracket. The elastic cushion includes a first and a second cavity for receiving receive a first rail or a second rail of the dual rail. The elastic cushion further includes at least one slot for enabling a lateral insertion of both rails of the dual rail into the cavities. The mounting bracket includes a recess for receiving the elastic cushion and a mounting mechanism for mounting the mounting bracket on a vehicle. The device further includes a fastening mechanism for fastening the mounting bracket on the elastic cushion.

### CROSS-REFERENCE TO RELATED APPLICATIONS

This application claims priority to and the benefit of DE 10 2022 122 262.4, filed on Sep. 2, 2022. The disclosure of the above application is incorporated herein by reference in its entirety.

### FIELD

The present disclosure relates to a device for mounting a dual rail on a vehicle and a method for mounting a dual rail on a vehicle.

### BACKGROUND

The statements in this section merely provide background information related to the present disclosure and may not constitute prior art.

Along with classical circular conductors and single rail systems, dual rail systems are also increasingly used in the field of e-mobility for the purpose of transmitting electrical energy, as they have advantages in terms of lower electromagnetic field radiation due to field canceling effects. The forces of linear expansion and vibrations arising from the vehicle which occur in the installation path of the rail have a direct effect on the components connected to the rail. It is strictly necessary to keep these forces away from the contact areas and simultaneously fasten the dual rail in the chassis. The fastening of the rail must retain the rail within the installation space on the chassis as well as be positioned directly at the interfaces to the components such as charging ports, switch boxes, or batteries. In the prior art, the fastening of the rail is currently realized by means of plastic components with corresponding spring geometries. In general, these cannot withstand the forces generated by an aluminum rail. The currently known solutions thus only retain the dual rail within the installation space but do not absorb the forces, natural oscillations, and vibrations which occur. Above all, the interfaces connected to the dual rail must be free of these forces, as the forces transmitted could otherwise transfer to the additional components, such as the charging port, switch box, or battery.

### SUMMARY

This section provides a general summary of the disclosure and is not a comprehensive disclosure of its full scope or all of its features.

The present disclosure provides an improved device for mounting a dual rail on a vehicle which is easier to assemble and can absorb the forces and vibrations of the dual rail in order to keep interfaces free of force.

The described forms apply equally to a device for mounting a dual rail on a vehicle as well as a method for mounting a dual rail on a vehicle. Synergistic effects can arise from various combinations of the forms, even if they are not described in detail.

It should further be noted that all forms of the present disclosure which relate to a method can be performed in the described order of steps. However, this does not need to be the only possible and necessary order of the steps of the method. The methods described herein can be performed in a different order of the disclosed steps without deviating from the corresponding form of the method, provided the opposite is not explicitly mentioned in the following.

A device for mounting a dual rail on a vehicle is proposed according to an aspect of the present disclosure. The device comprises an elastic cushion and a mounting bracket. The elastic cushion comprises a first cavity, which is configured for receiving a first rail of the dual rail, and a second cavity, which is configured for receiving a second rail of the dual rail. The elastic cushion comprises at least a first slot which is configured for enabling a lateral insertion of the first rail of the dual rail into the first cavity and a lateral insertion of the second rail of the dual rail into the second cavity. The mounting bracket comprises a recess which is configured for receiving the elastic cushion and a mounting mechanism which is configured for mounting the mounting bracket on a vehicle. The device furthermore comprises a fastening mechanism which is configured for fastening the mounting bracket on the elastic cushion.

The mounting device accordingly comprises two components which together enclose the dual rail, for example a high-voltage dual rail. The internal component, the elastic cushion, which can be made of silicone, has a slot on at least one side, in allow the insertion of the rails into the cavities provided for them and to be able to accommodate them separately from one another in the elastic cushion. The insertion of the rails is not possible only in longitudinal direction through the slots in the elastic cushion but also perpendicularly to the rail. The external component, the mounting bracket, can be positioned and pre-fastened over the elastic cushion after the elastic cushion has been affixed on the rails. To this end, the mounting bracket comprises a recess within which the elastic cushion can be received. A fastening mechanism on the elastic cushion and/or on the mounting bracket permits the pre-fastening of the elastic cushion and the mounting bracket to one another as well as the overall pre-fastening to the dual rail. This pre-fastening can especially retain the mounting bracket and the device in position on the dual rail as long as the device has not yet been fixedly connected to the vehicle by means of the mounting mechanism. The mounting bracket can thus serve as a screw connection point, while the elastic cushion encloses the rails and is held by the mounting bracket. Slotted holes can be provided on the mounting bracket as a mounting mechanism for screwing down the bracket in the installation space of the vehicle. The device can thus be affixed and screwed down in any position in the vehicle installation space.

By mounting or screwing down the device within the installation space of the vehicle, the dual rail contained therein can be compressed and fastened. The mounting can absorb the occurring forces, oscillations, and vibrations and thus keep them away from the interfaces. The positioning on the rail can in particular be performed immediately adjacent to the interfaces applied to the rail in order to be able to absorb the forces on the rail. To this end, the device can be affixed to the rail as often as desired in order for it to be held within the installation space.

The device according to the present disclosure is compatible with all components which would be present in the installation path of a high-voltage dual rail, and which is desirably free from the forces of longitudinal expansion or vibration. The system can be scaled to any dimensions of the high-voltage dual rail.

In one form of the present disclosure, the elastic cushion comprises a tab which is configured for separating the first cavity and the second cavity from one another. This tab can be especially affixed on an internal wall of the elastic cushion and project into a hollow space within the cushion in order to divide this hollow space into the first cavity and the second cavity. This tab can alternatively be designed as a connecting bridge between two halves of the elastic cushion. In the assembled state, the tab separates the two rails of the dual rail from one another and fills the intermediate space between the rails.

In one form of the present disclosure, the elastic cushion is configured for fully enclosing the first rail as well as the second rail of the dual rail over at least a portion of a length of the dual rail. The rail is thereby fully surrounded by the elastic cushion and only projects from the cushion at the front and at the rear. The rail consequently runs through the cushion, wherein both rails run parallel to one another. The cushion can be compressed especially in the assembled state so that the slot for inserting the rails is closed.

In one form of the present disclosure, the mounting bracket comprises an upper plate and a lower plate, wherein the upper place comprises the recess configured for receiving the elastic cushion, and the mounting bracket comprises a connecting mechanism configured for mutually connecting the upper plate and the lower plate and thereby enclose the elastic cushion between the upper plate and the lower plate. The mounting bracket can thus be configured in two parts, wherein the elastic cushion is received between the two parts of the mounting bracket and is enclosed by them in the two-part configuration. In this form, both parts of the mounting bracket are provided with a connecting mechanism that holds both parts together and which can optionally also hold the mounting bracket on the elastic cushion.

In one form of the present disclosure, the mounting bracket is designed to compress the elastic cushion and thereby fasten the first rail and the second rail of the dual rail in the elastic cushion. For example, the elastic cushion can be pressed onto the vehicle by the mounting bracket so that the cushion is thereby compressed and the first rail as well as the second rail of the dual rail are fastened in the elastic cushion. The compression of the cushion can alternatively take place between the upper part and the lower part of the mounting bracket, provided the bracket is configured in two parts.

In one form of the present disclosure, the elastic cushion comprises at least one strap and the mounting bracket comprises at least one opening, wherein the strap is affixed to an outer surface of the elastic cushion and is configured for engaging into the opening of the mounting bracket in order to fasten the mounting bracket on the elastic cushion. Additionally, or alternatively, the elastic cushion comprises an outer profile on an outer surface, and the mounting bracket comprises a corresponding inner profile on an inner surface, wherein the outer profile and the inner profile are configured for engaging with one another, and thereby fasten the mounting bracket on the elastic cushion. This combination of strap on the elastic cushion and an opening in the mounting bracket, or of an outer profile and an inner profile, can be understood as the fastening mechanism which fastens the mounting bracket on the elastic cushion. The strap is thereby pulled through the opening, wherein any slipping out can be avoided due to the shape of the strap or of the opening. In the alternative design, in particular in combination with the two-part design of the mounting bracket, the profiles which engage into one another can inhibit the elastic cushion from slipping out of both parts of the bracket.

In one form of the present disclosure, the elastic cushion comprises two straps, which are affixed on mutually opposite sides of the elastic cushion, and the mounting bracket comprises two openings configured for receiving the two straps of the elastic cushion in order to fasten the mounting bracket on the elastic cushion. The fastening and the assembly can thus be significantly improved.

In one form of the present disclosure, the mounting bracket comprises at least one bead and/or a raised edge in order to increase the stability of the mounting bracket. Beads affixed on the sides of the mounting bracket, especially in the curvature of the bracket, can stiffen the component. The edge of the bracket can additionally be set up in the upper area.

In one form of the present disclosure, the elastic cushion consists of a thermally conductive material or contains a thermally conductive material, and/or the mounting bracket is made of a plastic or metal, and in one variation stainless steel. Through the use of, for example, thermally conductive plastics, the device for mounting can also be used for cooling of the system, in particular of the rail and attached components. The plastic can thus absorb the heat of the rail and conduct it via the metal bracket to the vehicle chassis. The mounting bracket which can geometrically enclose the cushion can be made of metal, such as, for example, stainless steel or aluminum. Alternatively, the mounting bracket can be made of plastic.

According to a further aspect of the present disclosure, a method is disclosed for mounting a dual rail on a vehicle with a device according to one of the previous forms. The method comprises the step of making available a device according to one of the previous forms, as well as the step of inserting the first rail of the dual rail into the first cavity of the elastic cushion and the second rail of the dual rail into the second cavity of the elastic cushion. The method furthermore comprises the step of fastening the mounting bracket on the elastic cushion by means of the fastening mechanism, and the step of mounting the mounting bracket on the vehicle by means of the mounting mechanism.

The advantages offered by one of the aforementioned aspects apply equally to all other aspects and vice versa.

The present disclosure essentially relates to a device for mounting a dual rail on a vehicle. The device comprises an elastic cushion and a mounting bracket. The elastic cushion comprises a first and a second cavity for receiving a first rail or a second rail of the dual rail. The elastic cushion further comprises at least one slot for enabling a lateral insertion of both rails of the dual rail into the cavities. The mounting bracket comprises a recess for receiving the elastic cushion and a mounting mechanism for mounting the mounting bracket on a vehicle. The device furthermore comprises a fastening mechanism for fastening the mounting bracket on the elastic cushion.

Additional features, advantages, and application possibilities of the present disclosure arise from the following description of advantageous forms and the accompanying figures.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic representation of a device for mounting a dual rail on a vehicle according to one form of the present disclosure;

FIGS. 2A and 2B show schematic representations of an elastic cushion according to another form of the present disclosure from various viewpoints;

FIG. 3 shows a schematic representation of an elastic cushion mounted on a dual rail according to a further form of the present disclosure;

FIGS. 4A and 4B show schematic representations of a mounting bracket according to yet another form of the present disclosure from various viewpoints;

FIGS. 5A and 5B show schematic representations of a device for mounting a dual rail on a vehicle according to still a further form of the present disclosure from various viewpoints;

FIG. 6A shows a schematic representation of an elastic cushion according to a second form of the present disclosure;

FIG. 6B shows a schematic representation of an upper plate of a mounting bracket according to the second form of the present disclosure;

FIG. 6C shows a schematic representation of a lower plate of a mounting bracket according to the second form of the present disclosure;

FIGS. 7A and 7B show schematic representations of a device for mounting a dual rail on a vehicle according to the second form of the present disclosure;

FIGS. 8A and 8B show schematic representations of a device for mounting a dual rail on a vehicle according to a third form of the present disclosure;

FIG. 9 shows a schematic representation of a device mounted on a dual rail for mounting a dual rail on a vehicle according to the third form of the present disclosure;

FIG. 10A shows a schematic representation of an elastic cushion according to a fourth form of the present disclosure;

FIG. 10B shows a schematic representation of an upper part of a mounting bracket according to the fourth form of the present disclosure;

FIG. 10C shows a schematic representation of a lower part of a mounting bracket according to the fourth form of the present disclosure; and

FIGS. 11A and 11B show schematic representations of a device for mounting a dual rail on a vehicle according to the fourth form of the present disclosure.

The figures are merely schematic representations and only serve to illustrate the present disclosure. Identical elements or elements with identical function are always identified with the same reference numerals.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

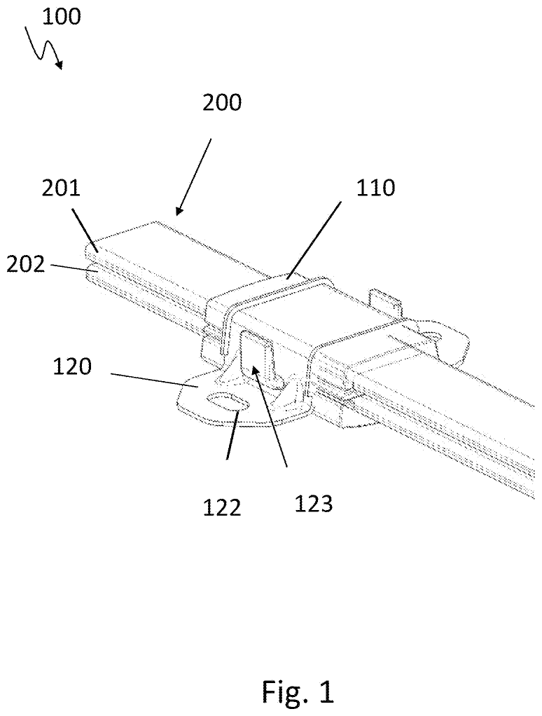

FIG. 1 shows a schematic depiction of a device 100 for mounting a dual rail 200 on a vehicle according to one form of the present disclosure. The device comprises an elastic cushion 110 and a mounting bracket 120. The first rail 201 and the second rail 202 of the dual rail 200 are inserted into both of the cavities 111 and 112 of the elastic cushion. The mounting bracket 120 is pre-fastened on the elastic cushion 110 by means of a fastening mechanism 123, which in the present image is a combination of a strap 118 on the elastic cushion 110 and an opening 128 on the mounting bracket 120. The device 100 can be mounted, for example, screwed down, in a vehicle by means of the mounting mechanism 122.

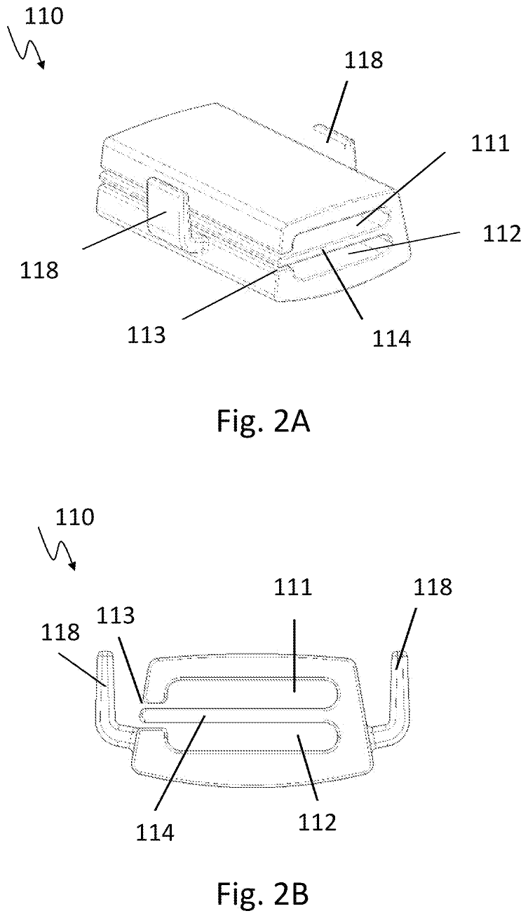

FIGS. 2A and 2B show schematic depictions of an elastic cushion 110 according to one form of the present disclosure from various viewpoints. The elastic cushion 110 comprises a first cavity 111 and a second cavity 112 for receiving the dual rail 200. A tab 114, which separates the cavities from one another, runs between the cavities. A slot 113 on the side of the elastic cushion 110 enables a lateral insertion of the rails of the dual rail 200 into the cavities 111 and 112. Two straps 118 which can be inserted into corresponding openings 128 of the mounting bracket are also affixed on the side of the elastic cushion 110.

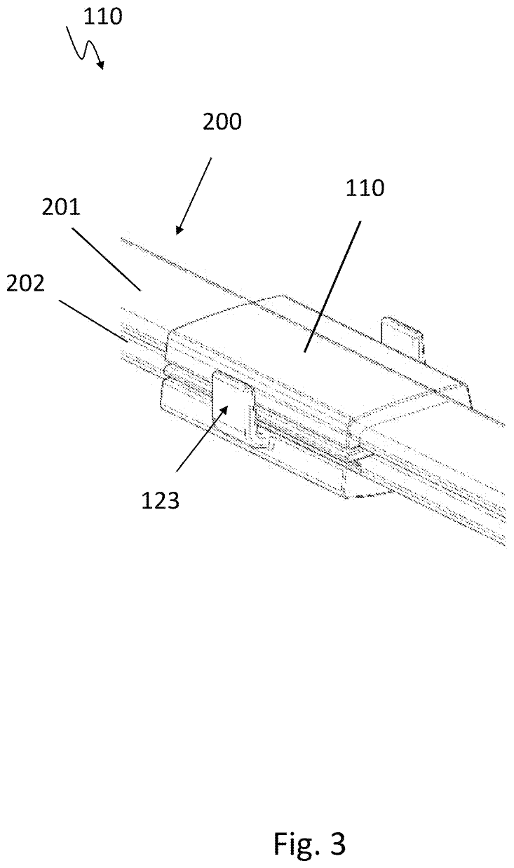

FIG. 3 shows a schematic representation of an elastic cushion 110 mounted on a dual rail 200 according to one form of the present disclosure. The first rail 201 and the second rail 202 of the dual rail 200 are inserted into the elastic cushion 110. The fastening mechanism 123 enables the pre-fastening of the elastic cushion 110 on the mounting bracket 120.

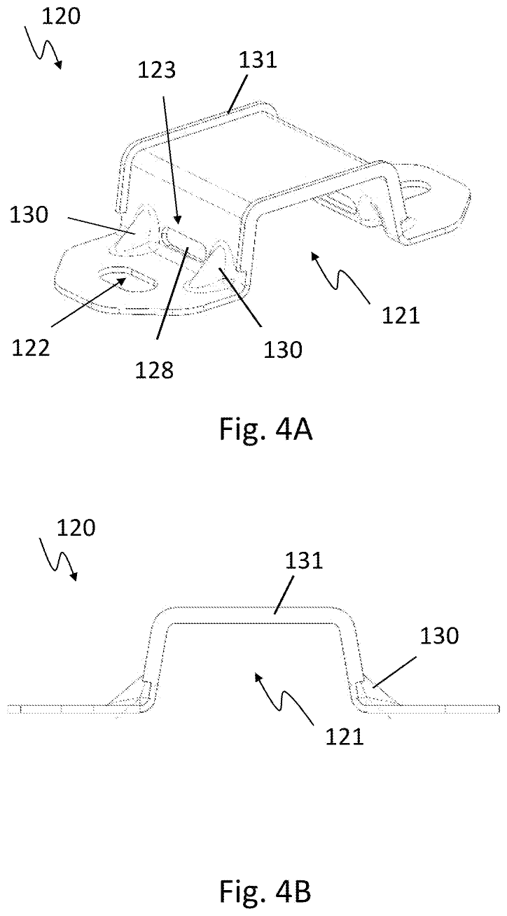

FIGS. 4A and 4B show schematic representations of a mounting bracket 120 according to one form of the present disclosure from various viewpoints. The mounting bracket 120 comprises a curved shape, so that it forms a recess 121 into which the elastic cushion 110 can be received. The fastening mechanism 123 is formed here by an opening 128 for receiving the strap 118 of the elastic cushion 110. A slotted hole serves as a mounting mechanism 122. Beads 130 for stiffening, as well as a raised edge 131 are affixed on the mounting bracket 120. In this form, the mounting bracket 120 can be made from sheet metal, which can be brought into shape using deep drawing or a similar shaping process.

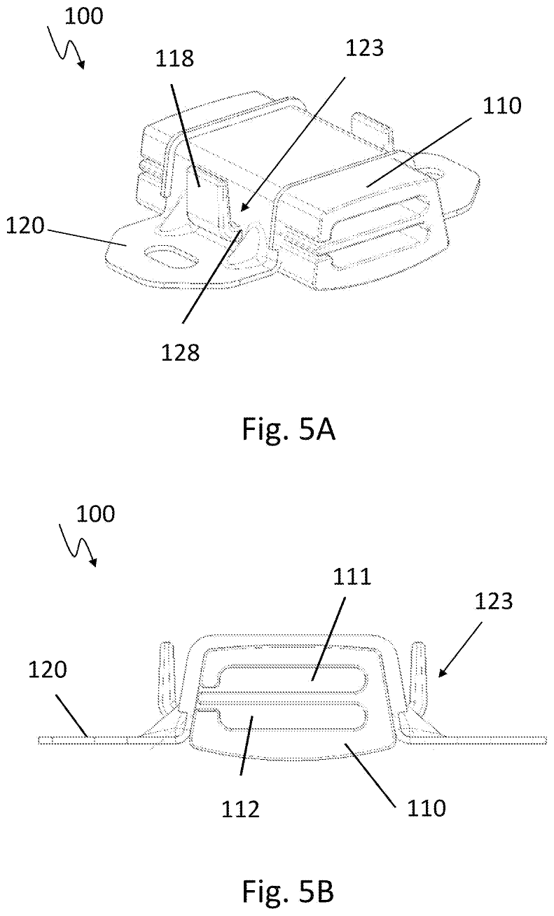

FIGS. 5A and 5B show schematic representations of a device 100 for mounting of a dual rail 200 on a vehicle according to one form of the present disclosure from various viewpoints. The elastic cushion 110 is received in the recess 121 of the mounting bracket 120 and is fastened in the opening by means of the strap 118 as a fastening mechanism 123. The first cavity 111 and the second cavity 112 are designed to receive the rails of the dual rail.

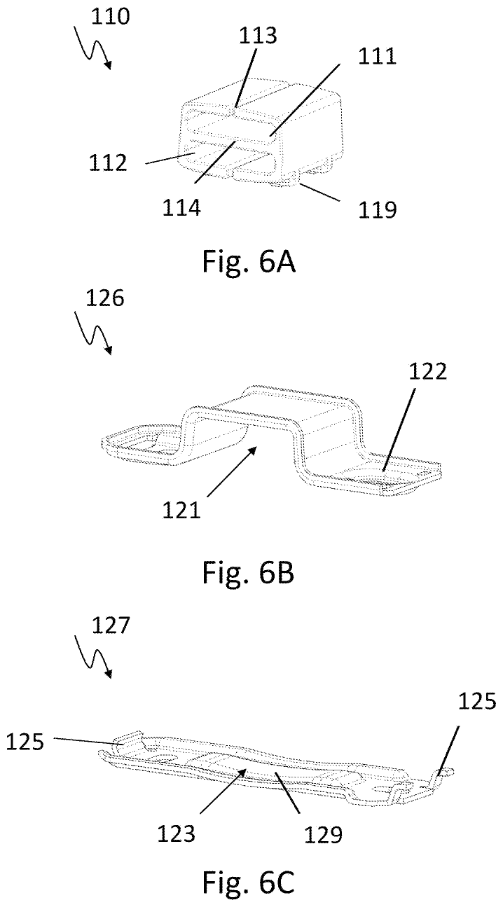

FIG. 6A shows a schematic representation of an elastic cushion 110 according to a second form of the present disclosure. The first cavity 111 and the second cavity 112 of the elastic cushion 110 are separated from one another by the tab 114. In this form, the elastic cushion 110 features two slots 113 for inserting the rails of the dual rail 200 in the respective cavity. An outer profile 119 of the elastic cushion 110 serves as part of the fastening mechanism 123 in this form.

FIG. 6B shows a schematic representation of an upper plate 126 of a mounting bracket 120 according to the second form of the present disclosure. Here, the upper plate 126 has the recess 121 for receiving the elastic cushion 110. The device 100 can be screwed onto the vehicle by means of the mounting mechanism 122.

FIG. 6C shows a schematic depiction of a lower plate 127 of a mounting bracket 120 according to the second form of the present disclosure. Here, the lower plate 127 features a connecting mechanism 125 for connection to the upper plate 126. It can be a latching mechanism. An inner profile 129 as a part of the fastening mechanism 123 serves for pre-fastening the elastic cushion 110 in the mounting bracket 120 in combination with the outer profile 119 of the elastic cushion 110.

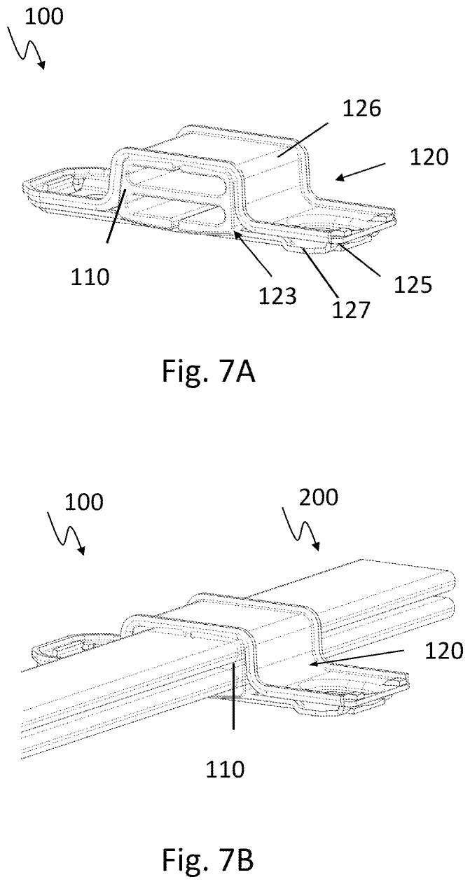

FIGS. 7A and 7B show schematic representations of a device 100 for mounting a dual rail 200 on a vehicle according to the second form of the present disclosure. The elastic cushion 110 is fastened between the upper plate 126 and the lower plate 127 of the mounting bracket 120 by means of the fastening mechanism 123. The parts of the connecting mechanism 125 connect the upper plate 126 to the lower plate 127. Both rails of the dual rail 200 are inserted into the elastic cushion 110. In this form, both plates 126, 127 of the mounting bracket 120 can be made from sheet metal which can be brought into shape using deep drawing or a similar shaping process.

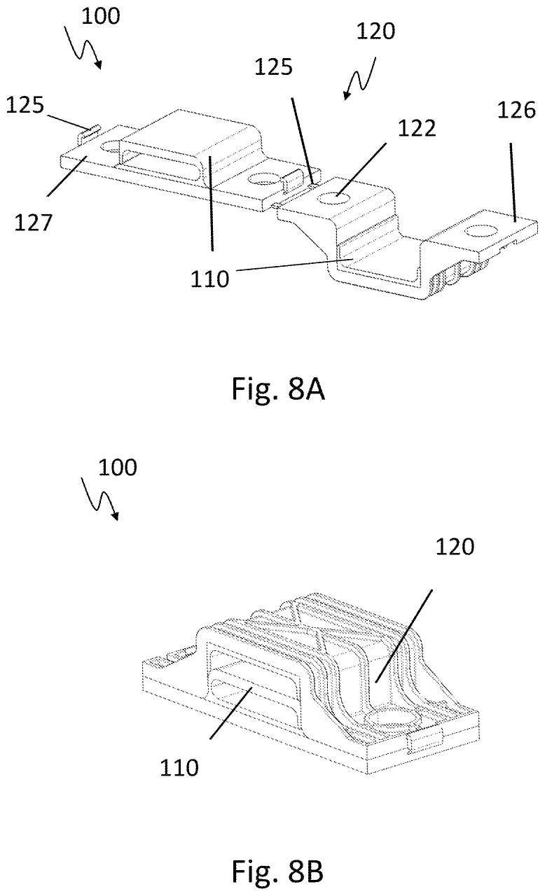

FIGS. 8A and 8B show schematic representations of a device 100 for mounting a dual rail 200 on a vehicle according to a third form of the present disclosure. In this form, the device can be made of plastic. It is also possible for the elastic cushion to be integrated as a holder into the mounting bracket as 2K component. The device 100 can be configured as a 2K injection mold, wherein the upper plate 126 can be connected to the lower plate 127 of the mounting bracket 120 with a film hinge as a connecting mechanism 125. The elastic cushion 110 can be divided here into two halves.

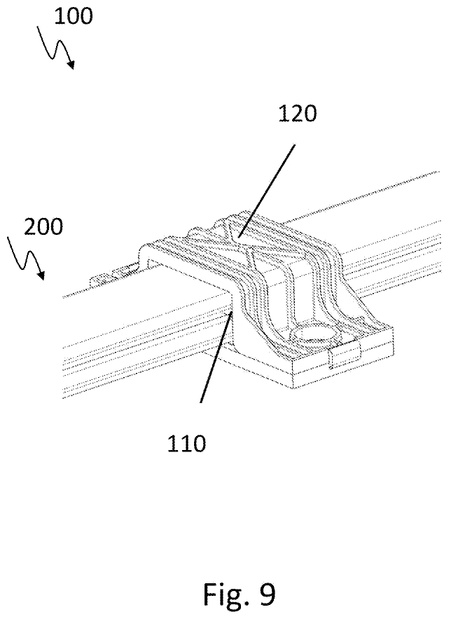

FIG. 9 shows a schematic representation of a device 100 mounted to a dual rail 200 for mounting a dual rail 200 on a vehicle according to the third form of the present disclosure. In this case, the first rail 201 of the dual rail 200 is first inserted into the first cavity 111 of the elastic cushion 110, and then both plates 126, 127 of the mounting bracket 120 are folded together, whereby the second rail 202 of the dual rail 200 is positioned in the second cavity 112 of the elastic cushion 110.

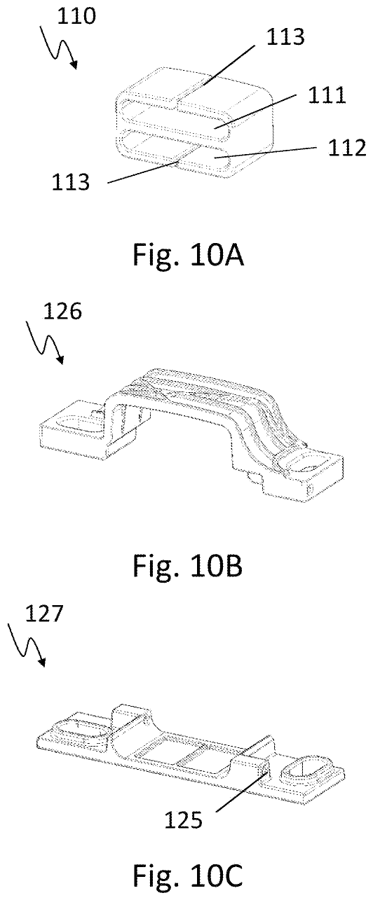

FIG. 10A shows a schematic representation of an elastic cushion 110 according to a fourth form of the present disclosure. Every cavity 111, 112 is hereby assigned its own slot 113. FIG. 10B shows a schematic representation of an upper part 126 of a mounting bracket 120 according to the fourth form of the present disclosure. FIG. 10C shows a schematic representation of a lower part127 of a mounting bracket 120 according to the fourth form of the present disclosure. The connecting mechanism 125 can be configured here in the form of a screw connection.

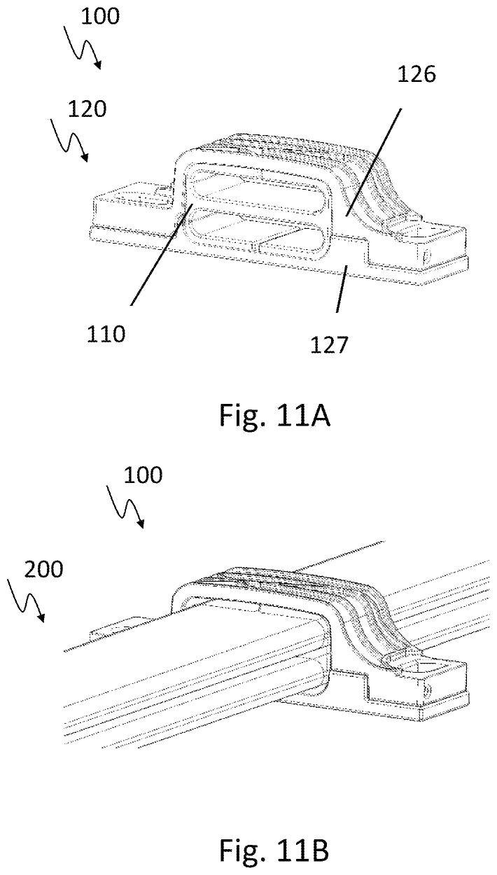

FIGS. 11A and 11B show schematic representations of a device 100 for mounting a dual rail 200 on a vehicle according to the fourth form of the present disclosure. The elastic cushion 110 is received between the upper plate 126 and the lower plate 127 of the mounting bracket 120. The dual rail 200 runs through the cavities of the elastic cushion 110. In this form of the present disclosure, the upper plate 126 as well as the lower plate 127 of the mounting bracket 120 can be configured, for example, as die-cast aluminum components.

Although the present disclosure is illustrated and described in detail in the drawings and the preceding description, these drawings and descriptions are to be understood as illustrative or exemplary, and not to be considered as restrictive. The present disclosure is not limited to the disclosed forms. Other variations of the disclosed forms can be understood and realized by persons skilled in the art who implement the claimed disclosure based on the drawings, the disclosure, and the dependent claims.

It should be additionally noted that “comprising” does not exclude all other elements and “a” or “one” does not exclude a plurality. It is further noted that features or steps described with reference to one of the preceding exemplary forms can also be used in combination with other features or steps of other previously described exemplary forms.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A device for mounting a dual rail on a vehicle, wherein the device comprises:
an elastic cushion comprising:
a first cavity configured for receiving a first rail of the dual rail;
a second cavity configured for receiving a second rail of the dual rail; and
at least a first slot configured for enabling a lateral insertion of the first rail of the dual rail into the first cavity and a lateral insertion of the second rail of the dual rail into the second cavity;
a mounting bracket comprising:
a recess designed for receiving the elastic cushion; and
a mounting mechanism configured for mounting the mounting bracket on a vehicle; and
a fastening mechanism configured for fastening the mounting bracket on the elastic cushion.

2. The device according to claim 1, wherein the elastic cushion comprises a tab configured for separating the first cavity and the second cavity from one another.

3. The device according to claim 1, wherein the elastic cushion is configured for fully enclosing the first rail as well as the second rail of the dual rail over at least a portion of a length of the dual rail.

4. The device according to claim 1,
wherein the mounting bracket comprises an upper plate and a lower plate,
the upper plate comprises the recess configured for receiving the elastic cushion, and
the mounting bracket comprises a connecting mechanism configured for connecting the upper plate and the lower plate to one another, and for thereby enclosing the elastic cushion between the upper plate and the lower plate.

5. The device according to claim 1, wherein the mounting bracket is configured for compressing the elastic cushion and thereby fastening the first rail and the second rail of the dual rail in the elastic cushion.

6. The device according to claim 1,
wherein the elastic cushion comprises at least one strap, and the mounting bracket comprises at least one opening, the strap being affixed to an outer surface of the elastic cushion and configured for engaging in the opening of the mounting bracket in order to fasten the mounting bracket to the elastic cushion, and
the elastic cushion comprises an outer profile on the outer surface, and the mounting bracket comprises a corresponding inner profile on an inner surface, the outer profile and the inner profile configured for engaging with one another, and for thereby fastening the mounting bracket on the elastic cushion.

7. The device according to claim 1, wherein the elastic cushion comprises two straps affixed on mutually opposite sides of the elastic cushion, and the mounting bracket comprises two openings configured for receiving the two straps of the elastic cushion to fasten the mounting bracket on the elastic cushion.

8. The device according to claim 1, wherein the mounting bracket comprises at least one bead configured to increase a stability of the mounting bracket.

9. The device according to claim 1, wherein the mounting bracket comprises a raised edge configured increase a stability of the mounting bracket.

10. The device according to claim 1, wherein the elastic cushion comprises a thermally conductive material.

11. The device according to claim 10, wherein the mounting bracket comprises a plastic material.

12. The device according to claim 10, wherein the mounting bracket comprises a metal material.

13. The device according to claim 12, wherein the metal material is stainless steel.

14. A method for mounting a dual rail on a vehicle with the device according to claim 1, wherein the method comprises:
making a device according to claim 1;
inserting the first rail of the dual rail into the first cavity and the second rail of the dual rail into the second cavity of the elastic cushion;
fastening the mounting bracket on the elastic cushion by the fastening mechanism; and
mounting the mounting bracket on the vehicle by the mounting mechanism.
